(19) United States
(12) Patent Application Publication
(10) Pub. No.: US 2026/0152589 A1
(43) Pub. Date: Jun. 4, 2026

(54) POLYETHYLENE COMPOSITIONS AND FILMS MADE THEREFROM

(71) Applicant: ExxonMobil Chemical Patents Inc., Spring, TX (US)

(72) Inventors: Martin ANTENSTEINER, Houston, TX (US); Aaron C. MCGINNIS, Houston, TX (US); Wen LI, Houston, TX (US)

(21) Appl. No.: 19/102,947

(22) PCT Filed: Jul. 17, 2023
(86) PCT No.: PCT/US2023/070307

§ 371 Date: Feb. 11, 2025

Related U.S. Application Data
(60) Provisional application No. 63/373,154, filed on Aug. 22, 2022.

(51) Int. Cl. C08F 210/16; C08F 4/6592; C08J 5/18

(52) U.S. Cl. CPC C08F 210/16; C08F 4/65922; C08J 5/18; C08F 2500/08; C08F 2500/26; C08J 2323/08

(57) ABSTRACT

A polyethylene copolymer useful in producing blown films may include: ethylene units; and 0.1 mol % to 15 wt % of C3-C18 alpha-olefin comonomer units, the polyethylene copolymer having: a density of 0.900 g/cm3 to 0.915 g/cm³, a melt index (MI, determined per ASTM D1238-20 at 190° C. and 2.16 kg loading) (12) of 0.5 g/10 min to 1.5 g/10 min. a melt index ratio of 15 to 40, a cross-fractional chromatography (CFC) central cross moment covariance of less than −500K (kg/mol), a CFC correlation of −0.3 or less, a CFC equal halves Tw1-Tw2 of −30° C. or less and Mw1/Mw2 of 2 or greater, and a temperature rising elution fraction (TREF) T75-T25 30° C. to 36° C.

### CROSS-REFERENCE TO RELATED APPLICATION

This application claims the benefit of U.S. Provisional Application No. 63/373,154, filed Aug. 22, 2022, entitled “Polyethylene Compositions and Films Made Therefrom”, the entirety of which is incorporated by reference herein.

### FIELD OF INVENTION

The present disclosure relates to polyethylene polymers, polymerization processes for making such polyethylene polymers, and films made therefrom.

### BACKGROUND

A linear low density polyethylene (LLDPE) is a substantially linear polymer composed of ethylene monomeric units and alpha-olefin comonomeric units. The typical comonomeric units used are derived from 1-butene, 1-hexene, or 1-octene. An LLDPE may be distinguished from a conventional low density polyethylene (LDPE) in several ways including different manufacturing processes.

LLDPE traditionally have good toughness and stiffness properties that make LLDPEs useful in packaging materials like food packaging materials. However, LLDPE often require higher sealing temperatures to achieve a desired seal strength.

Some references of potential interest in this regard include: U.S. Pat. Nos. 6,255,426; 7,951,873; 8,247,065; 8,227,564; 8,765,874; 9,718,896; and 10,029,226; as well as US Patent Publication Nos. US2004/0121098; US2007/0260016; US2013/0266789; US2015/0232589; and US2020/0339715; and PCT Publication No. WO 2015/123164.

### SUMMARY OF INVENTION

The present disclosure relates to polyethylene polymers, polymerization processes for making such polyethylene polymers, and films made therefrom.

For example, a polyethylene copolymer may comprise: ethylene units; and 0.1 mol % to 15 wt % of C₃-C₁₈ alpha-olefin comonomer units, the polyethylene copolymer having: a density of 0.900 g/cm³ to 0.915 g/cm³, a melt index (MI, determined per ASTM D1238-20 at 190° C. and 2.16 kg loading) (12) of 0.5 g/10 min to 1.5 g/10 min, a melt index ratio of 15 to 40, a cross-fractional chromatography (CFC) central cross moment covariance of less than −500 K (kg/mol), a CFC correlation of −0.3 or less, a CFC equal halves Tw1-Tw2 of −30° C. or less and Mw1/Mw2 of 2 or greater, and a temperature rising elution fraction (TREF) T75-T25 30° C. to 36° C.

For example, a blown film may comprise: a polyethylene copolymer comprising: ethylene units; and 0.1 mol % to 15 wt % of C₃-C₁₈ alpha-olefin comonomer units, the polyethylene copolymer having: a density of 0.900 g/cm³ to 0.915 g/cm³, a melt index (MI, determined per ASTM D1238-20 at 190° C. and 2.16 kg loading) (12) of 0.5 g/10 min to 1.5 g/10 min, a melt index ratio of 15 to 40, a cross-fractional chromatography (CFC) central cross moment covariance of less than −500 K (kg/mol), a CFC correlation of −0.3 or less, a CFC equal halves Tw1-Tw2 of 30° C. or less and Mw1/Mw2 of 2 or greater, and a temperature rising elution fraction (TREF) T75-T25 30° C. to 36° C.

These and other features and attributes of the disclosed compositions, methods, and articles (e.g., films) of the present disclosure and their advantageous applications and/or uses will be apparent from the detailed description which follows.

### BRIEF DESCRIPTION OF THE FIGURE

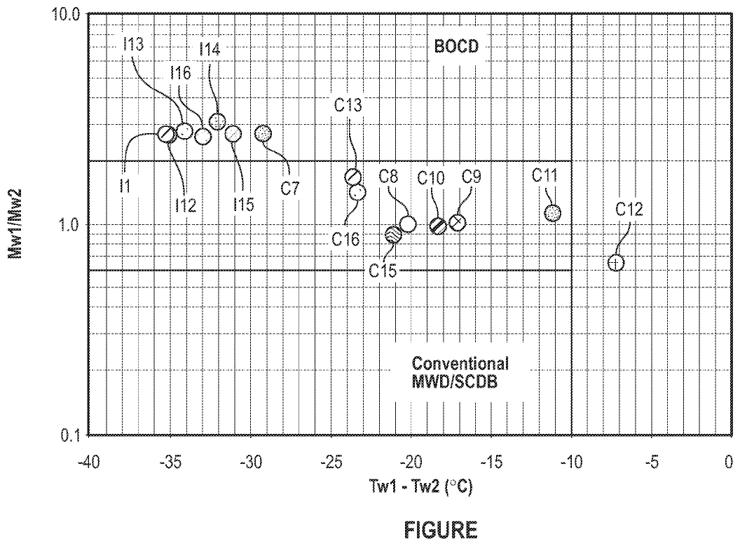

To assist those of ordinary skill in the relevant art in making and using the subject matter hereof, reference is made to the appended FIGURE. The following FIG. 1s included to illustrate certain aspects of the disclosure and should not be viewed as exclusive configurations. The subject matter disclosed is capable of considerable modifications, alterations, combinations, and equivalents in form and function, as will occur to those skilled in the art and having the benefit of this disclosure.

The FIG. 1s a plot of (Mw1/Mw2) vs. (Tw1-Tw2) for the inventive and comparative samples.

### DETAILED DESCRIPTION

The present disclosure relates to polyethylene polymers, polymerization processes for making such polyethylene polymers, and films made therefrom. More specifically, the polyethylene polymers of the present disclosure have a reduced density and increased melt index, which advantageously improves the sealing properties of films produced therefrom. For example, the polyethylene polymers of the present disclosure, advantageously, may maintain toughness properties (e.g., Elmendorf tear) while decreasing a temperature need to achieve a seal of a specific strength (e.g., hot tack initiation temperature) and/or increasing the strength of a seal produced within a sealing temperature range (e.g., max hot tack force).

### Definitions

As used herein, an “olefin,” alternatively referred to as “alkene,” is a linear, branched, or cyclic compound of carbon and hydrogen having at least one double bond. For purposes of this specification and the claims appended thereto, when a polymer or copolymer is referred to as “comprising” an olefin, olefin units, or olefin-derived units, the olefin present in such polymer or copolymer is the polymerized form of the olefin. For example, when a copolymer is described as having an “ethylene” content of 35 wt % to 55 wt %, or having 35% to 55% ethylene units, it is understood that the mer unit in the copolymer is derived from ethylene in the polymerization reaction and the derived units are present at 35 wt % to 55 wt %, based upon the weight of the copolymer.

As used herein, the terms “polyethylene polymer,” “polyethylene,” “ethylene polymer,” “ethylene copolymer,” and “ethylene based polymer” mean a polymer or copolymer comprising at least 50 mol % ethylene units, or at least 70 mol % ethylene units, or at least 80 mol % ethylene units, or at least 90 mol % ethylene units, or at least 95 mol % ethylene units or 100 mol % ethylene units (in the case of a homopolymer).

As used herein, a “polymer” may refer to homopolymers, copolymers, interpolymers, terpolymers, etc. A “polymer” has two or more of the same or different monomer units. A “homopolymer” is a polymer having monomer units that are the same. A “copolymer” is a polymer having two or more monomer units that are different from each other. A “terpolymer” is a polymer having three monomer units that are different from each other. The term “different” as used to refer to monomer units indicates that the monomer units differ from each other by at least one atom or are different isomerically. Accordingly, the definition of copolymer, as used herein, includes terpolymers and the like. Likewise, the definition of polymer, as used herein, includes copolymers and the like.

As used herein, an ethylene polymer having a density of more than 0.860 g/cm³ to less than 0.910 g/cm³ is referred to as an ethylene plastomer or plastomer; an ethylene polymer having a density of 0.910 g/cm³ to 0.925 g/cm³ is referred to as a “linear low density polyethylene” (LLDPE) when substantially linear (having minor or no long chain branching) as is typically the case for Ziegler-Nata or metallocene-catalyzed PE or branched low density polyethylene (LDPE) when significantly branched (having a high degree of long chain branching), as is often the case with free-radical polymerized PE: 0.925 g/cm³ to 0.940 g/cm³ is referred to as a “medium density polyethylene” (MDPE); and an ethylene polymer having a density of more than 0.940 g/cm³ is referred to as a “high density polyethylene” (HDPE). Density is determined according to ASTM D1505-18. Specimens are prepared according to ASTM D4703-16-Annex 1 Procedure C followed by conditioning according to ASTM D618-21-Procedure A prior to testing.

As used herein, and unless otherwise specified, the term “Cn” means hydrocarbon(s) having n carbon atom(s) per molecule, wherein n is a positive integer.

As used herein, and unless otherwise specified, the term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated or unsaturated), including mixtures of hydrocarbon compounds having different values of n.

As used herein, the term “film” refers to a continuous, flat (in some instances, flexible) polymeric structure having an average thickness of a range of 0.1 μm, or 1 μm, or 5 μm, or 10 μm, or 15 μm, or 20 μm to 50 μm, or 75 μm, or 100 μm, or 150 μm, or 200 μm, or 250 μm, or 1000 μm, or 2000 μm, or such a coating of similar thickness adhered to a flexible, non-flexible or otherwise solid structure. The “film” may be made from or contain a single layer or multiple layers. Each layer may be made from or contain the polyethylene copolymers of the present disclosure. For example, one or more layers of a “film” may include a mixture of the disclosed polyethylene copolymer as well as a LDPE, another LLDPE, polypropylene, or a plastomer.

As used herein, a composition or film “free of” a component refers to a composition/film substantially devoid of the component, or comprising the component in an amount of less than about 0.01 wt %, by weight of the total composition.

### Polyethylene Copolymer

The present disclosure provides polyethylene copolymers having a combination of low density and high melt index, maintained small amount of long chain branching, and a broad orthogonal composition distribution (BOCD) (low Tw1-Tw2 and high Mw1/Mw2 measured by cross-fractional chromatography). In addition, the polyethylene copolymers and films thereof can be formed by commercially desirable polymerizations and extrusions of the polyethylene copolymers, where the resultant films have a lower seal initiation temperature and higher tack force.

Thus, polyethylene copolymers of various embodiments herein can exhibit one or more of the following properties:
Density within the range from 0.900 g/cm³ to 0.915 g/cm³, such as from a low of any one of 0.900 g/cm³, 0.901 g/cm³, 0.902 g/cm³, 0.903 g/cm³, 0.904 g/cm³, 0.905 g/cm³, or 0.906 g/cm³ to a high of any one of 0.915 g/cm³, 0.914 g/cm³, 0.913 g/cm³, 0.912 g/cm³, 0.911 g/cm³, 0.910 g/cm³, or 0.909 g/cm³, such as 0.900 g/cm³ to 0.914 g/cm³, alternatively 0.900 g/cm³ to 0.912 g/cm³, with combinations from any low to any high contemplated (provided the high end is greater than the low end), e.g., 0.902 g/cm³ to 0.913 g/cm³. Density is measured by ASTM D1505-18, column density where samples were molded under ASTM D4703-16, Procedure C, then conditioned under ASTM D618-21 (23°±2° C. and 50±10% relative humidity) for 40 hours before density testing.
Melt Index (MI, also referred to as 12 or 12.16 in recognition of the 2.16 kg loading used in the test) greater than 1.0 g/10 min (ASTM D1238-20, 190° C., 2.16 kg), such as within the range from a low of any one of 0.5 g/10 min, 0.6 g/10 min, 0.7 g/10 min, 0.8 g/10 min, 0.9 g/10 min, or 1.0 g/10 min to a high end of any one of 0.9 g/10 min, 1.0 g/10 min, 1.1 g/10 min, 1.2 g/10 min, 1.3 g/10 min, 1.4 g/10 min, or 1.5 g/10 min, with ranges from any low end to any high end contemplated herein (provided the high end is greater than the low end), such as 0.5 g/10 min to 0.9 g/10 min, or 0.7 g/10 min to 1.5 g/10 min, such as 1.3 g/10 min, etc.
Melt index ratio (MIR, defined as the ratio of I21/I2 or I21.6/I2.16, I21 or HMLI measurement described hereinbelow) within the range from a low of any one of 15, 16, 17, 18, 19, 20, 21, 22, 23, 24, 25, or 26 to a high of any one of 26, 27, 28, 29, 30, 31, 32, 33, 34, 35, 36, 37, 38, 39, or 40 with ranges from any of the foregoing lows to any of the foregoing highs contemplated herein (e.g., 15 to 27, such as 24 to 38, or 27 to 32).
Cross Fractional Chromatography (CFC) Equal Halves Analysis (described hereinbelow) having (a) a Tw1-Tw2 of −30° C. or less, or within the range from a low of any one of −40° C., −39° C., −38° C., −37° C., −36° C., or −35° C. to a high of any one of −33° C., −32° C., −31° C., or −30° C. with ranges from any of the foregoing lows to any of the foregoing highs contemplated herein (provided the high end is greater than the low end) (e.g., −40° C. to −30° C., such as −37° C. to −30° C., or −36° C. to −31° C.) and (b) a Mw1/Mw2 of 2.0 or greater, or within the range from a low of any one of 2.0, 2.1, 2.2, 2.3, 2.5, 2.5, or 2.6 to a high of any one of 3.0, 3.1, 3.2, 3.3, 3.4, or 3.5 with ranges from any of the foregoing lows to any of the foregoing highs contemplated herein (provided the high end is greater than the low end) (e.g., 2.0 to 3.5, such as 2.4 to 3.5, or 2.5 to 3.2), which indicates a broad orthogonal composition distribution (BOCD).
CFC central cross moment covariance (described hereinbelow) of −500 K (kg/mol) or less, or within the range from a low of any one of −2200 K (kg/mol), −2100 K (kg/mol), −2000 K (kg/mol), −1900 K (kg/mol), or −1800 K (kg/mol) to a high of any one of −1300 K (kg/mol), −1200 K (kg/mol), −1100 K (kg/mol), −1000 K (kg/mol), −900 K (kg/mol), −800 K (kg/mol), −700 K (kg/mol), −600 K (kg/mol), or −500 K (kg/mol) with ranges from any of the foregoing lows to any of the foregoing highs contemplated herein (provided the high end is greater than the low end) (e.g., −2200 K (kg/mol) to −500 K (kg/mol), such as −2200 K (kg/mol) to −1000 K (kg/mol), or −2000 K (kg/mol) to −1200 K (kg/mol), or −2000 K (kg/mol) to −1300 K (kg/mol)).
CFC correlation (described hereinbelow) of 2.5 or greater, or within the range from a low of any one of 2.5, 2.6, 2.7, 2.8, 2.9, 3.0, 3.5, 4.0, 4.5, 5.0, or 5.5 to a high of any one of 6.0, 6.5, 7.0, 7.5, or 8.0 with ranges from any of the foregoing lows to any of the foregoing highs contemplated herein (provided the high end is greater than the low end) (e.g., 2.5 to 8.0, such as 2.5 to 6.5, or 2.5 to 3.5, or 3.0 to 8.0).
Temperature Rising Elution Fraction (TREF) T75 minus T25 (T75-T25) (described hereinbelow) from a low of any one of 30° C., 30.0° C., 30.5° C., or 31.0° C., to a high of any one of 34.0° C., 35.0° C., 35.5° C., or 36° C., with ranges from any foregoing low end to any foregoing high end contemplated herein, for instance, 30° C. to 36° C., or 30.0° C. to 35.0° C.).

Composition distribution (or comonomer distribution) refers to the distribution of comonomer, or short-chain branching (SCB), into polymer chains of different lengths (different molecular weights). Ethylene-based polymers of the present disclosure exhibit relatively constant or homogenous distribution of comonomer along chains of different length, with some variation evidenced.

For instance, the ethylene-based polymer can have a composition distribution breadth index (CDBI) within the range from a low of any one of 30%, 31%, 32%, 33%, 34%, or 35%, or 74% to a high of any one of 40%, 42%, 42%, 43%, 44%, or 45%, with ranges from any foregoing low end to any foregoing high end contemplated (e.g., a CDBI of 30% to 45%, or 30% to 40%). CDBI is defined as the weight percent of the copolymer molecules having a comonomer content within 50% of the median total molar comonomer content (i.e., within +/−25% of the median), and it is referenced, e.g., in U.S. Pat. No. 5,382,630. In general, copolymers with a broader distribution (meaning a greater difference between (i) comonomer incorporation on high-molecular-weight polymer chains and (ii) comonomer incorporation on low-molecular-weight polymer chains) result in a lower CDBI, while a theoretical copolymer with exactly the same relative comonomer content across all different lengths of polymer chains within +/−25% of the median length (median molecular weight) would have a CDBI of 100%. The CDBI of a copolymer is readily determined utilizing a technique for isolating individual fractions of a sample of the copolymer. One such technique is generation of a solubility distribution curve using Temperature Rising Elution Fraction (TREF), as described in WO 1993003093 (which in turn references Wild, et al., J. Poly. Sci., Poly. Phys. Ed., vol. 20, p. 441 (1982) and U.S. Pat. No. 5,008,204 in this regard). All three of the foregoing publications are incorporated herein by reference.

The solubility distribution curve can be first generated for the copolymer using data acquired from TREF techniques (as described, e.g., in the just-referenced publications). This solubility distribution curve is a plot of the weight fraction of the copolymer that is solubilized as a function of temperature. This can be converted to a weight fraction versus composition distribution curve. For the purpose of simplifying the correlation of composition with elution temperature the weight fractions less than 15,000 can be ignored. These low weight fractions generally represent a trivial portion of the ethylene-based polymers disclosed herein.

Alternatively or additionally, the composition or comonomer distribution can be understood with reference to the T75-T25 value, wherein T25 is the temperature at which 25% of the eluted polymer is obtained and T75 is the temperature at which 75% of the eluted polymer is obtained, both in a TREF experiment (and plotting of eluted polymer weight percentages vs. elution temperatures) as described in US2019/0119413 (especially in paragraphs [0055]-[0058] thereof, which description is incorporated by reference herein). A narrow distribution is indicated by a relatively small difference in the T75-T25 value (and in particular in conjunction with a high CDBI value), while a broad distribution is reflected in a relatively larger difference in the T75-T25 value (and in particular in conjunction with smaller CDBI value), implying greater differences in crystallinity between fractions of the polymer composition. It is also noted that, in the event of discrepancies between the actual TREF procedure as described in US2019/0119413 vs. the TREF procedure as described in WO 1993003093, U.S. Pat. Nos. 5,382,630, and/or 5,008,204, the TREF procedure as described in US2019/0119413 should be used. (Note further that the curves generated ancillary to the TREF procedures-solubility distribution curve for CDBI, and eluted weight percentages vs elution temperature for T75-T25, may have appropriate differences in their generation and analysis for CDBI and T75-T25.) Finally, the TREF curve (eluted polymer weight percentages vs elution temperatures) generated in connection with T75-T25 measurements can be further processed as follows:
1. The solvent-only response of the instrument can be generated and subtracted from the TREF curve of the sample. The solvent-only response can be generated by running, typically before, the same method as used for the polymer sample, but without any polymer added to the sample vial; using the same solvent reservoir as for the polymer sample and without replenishing with fresh solvent; and within a reasonable proximity of time from the run for the polymer sample.
2. The temperature axis of the TREF curve can be appropriately shifted to correct for the delay in the IR signal caused by the column-to-detector volume. This volume can be obtained by first filling the injection-valve loop with a ˜1 mg/ml solution of an HDPE resin; then loading the loop volume in the same location within the column where a sample is loaded for TREF analysis; then directly flowing, at a constant flow rate of 1 ml/min, the hot solution towards the detector using an isothermal method; and then measuring the time after injection for the HDPE probe's peak to appear in the IR signal. The delay volume (ml) is therefore equated to the time (min).
3. The curve can be baseline corrected and appropriate integration limits can be selected. And the curve can be normalized so that the area of the curve is 100 wt %.

Similarly, the known cross fractionation chromatography (CFC) equal halves analysis technique can be used to determine TW1, TW2, Mw1, and Mw2 values. The CFC method and determination of Tw1, Tw2, Mw1, Mw2 is described in U.S. Patent Application Publication No. US2022/0048016 (Paragraphs 622-634 and FIGS. 2-3 therein), incorporated herein by reference. Summarizing from that publication, Tw1 and Tw2 represent: the average temperature at which the first half of polymer eluted (Tw1) and the average temperature at which the second half (Tw2) eluted during the CFC experiment, noting that higher temperature of elution infers greater crystallinity; ergo, the temperatures Tw1 and Tw2 can be used to infer the presence of two distinctly crystalline fractions, and the difference between these can be used to infer the difference in degree of crystallinity among those fractions. Mw1 and Mw2 represent the average weight-average molecular weights of the first (Mw1) and second (Mw2) fractions of eluting polymer, which can be used to infer the relative amounts of lower- and higher-crystallinity fraction in the polymer.

Cross Fractional Chromatography, CFC (also known as TREF-GPC): Cross-fractionation chromatography (CFC) analysis was done using a CFC-2 instrument from Polymer Char, S. A., Valencia, Spain. The principles of CFC analysis and a general description of the particular apparatus used are given in the article Ortin, A.; Monrabal, B.; Sancho-Tello, J. Macromol. Symp. 2007, 257, 13. FIG. 1 of the foregoing article is an appropriate schematic of the particular apparatus used. The IR4 (Polymer Char) infrared detector was used to generate an absorbance signal that is proportional to the concentration of polymer in the eluting flow. Pertinent details of the analysis method and features of the apparatus used are as follows.

The solvent used for preparing the sample solution and for elution was 1,2-dichlorobenzene (ODCB) which was stabilized by dissolving 2 g of 2,6-bis(1,1-dimethylethyl)-4-methylphenol (butylated hydroxytoluene) in a 4-L, bottle of fresh solvent at ambient temperature. The sample to be analyzed (50-65 mg) was dissolved in the solvent (25 ml metered at ambient temperature) by stirring (200 rpm) at 150° C. for 75 min. A small volume (0.5 ml) of the solution was introduced into a TREF column (stainless steel; o.d., ⅜″; length, 15 cm; packing, non-porous stainless steel micro-balls) at 150° C., and the column temperature was stabilized for 30 min at a temperature (120-125° C.) approximately 20° C. higher than the highest-temperature fraction for which the GPC analysis was included in obtaining the final bivariate distribution. The sample volume was then allowed to crystallize in the column by reducing the temperature to an appropriate low temperature (0° C.) at a cooling rate of 0.2° C./min. The low temperature was held for 10 min before injecting the solvent flow (1 ml/min) into the TREF column to elute the soluble fraction (SF) into the GPC columns (3×PLgel 10 μm Mixed-α 300×7.5 mm, Agilent Technologies, Inc.); the GPC oven was held at high temperature (140° C.). The SF was eluted for 5 min from the TREF column and then the injection valve was put in the “load” position for 40 min to completely elute all of the SF through the GPC columns (standard GPC injections). All subsequent higher-temperature fractions were analyzed using overlapped GPC injections wherein at each temperature step the polymer was allowed to dissolve for at least 16 min and then eluted from the TREF column into the GPC column for 3 min.

The set-point temperatures for these higher-temperature fractions were determined from the cumulative curve of the normalized (100 wt %) TREF curve of the same sample. The width of each temperature step, starting from the temperature of the SF, is progressively set such that a targeted 1.5 wt % of polymer mass, as indicated by the TREF cumulative curve, would elute in the temperature range of the step. However, because the temperature set-points are restricted to integer values, each step is chosen such that the polymer mass eluting in it is as close to 1.5 wt % as possible before computing the next, higher-temperature step. If greater than 1.5 wt % would elute in the minimum step size of 1° C., then the step size is set to 1° C. If the computed step size exceeds 10° C., then the step size is restricted to a maximum of 10° C. before computing the width of the next, higher-temperature step. The computation of such steps is concluded when the sum of percent polymer mass accounted in each step including the SF is 100 wt %. Additionally, two or more 1° C. steps are added to ensure a complete elution of the injected polymer. The choice of 1.5 wt % is arrived at by targeting 30-35 fractions (including the SF) for the complete CFC analysis of the polymer. The computation of steps, as described above, may be done manually or with the aid of a computer program.

The correlation (also referred to herein as CFC correlation factor, or simply CFC correlation) and covariance (also referred to herein as central CFC cross monomer covariance, or CFC central cross moment of variance) are determined mathematically from the 2d differential distribution of wt % polymer as a function of elution temperature and log (M) of the same sample. The 2d differential distribution is obtained in a rectangular grid with one axis being the temperature and the other axis being log (M). The grid points on the temperature axis range from 0 to 120 C and are 1 C apart; the grid points on the log (M) axis are from 2 to 8 and are 0.1 units apart. The soluble fraction is not included in the 2d differential distribution, and for any rectangular area element of the grid, the volume under the distribution surface is equal to the wt % of crystallized polymer that eluted within that temperature and log (M) range during the analysis. Correlation and covariance are common statistical technique known to those in the art. See Rice, John (2007), Mathematical Statistics and Data Analysis, Belmont, CA, Brooks/Cole Cengage Learning (e.g., p. 138), ISBN 978-0534-39942-9.

The universal calibration method was used for determining the molecular weight distribution (MWD) and molecular-weight averages (Mn, Mw, etc.) of eluting polymer fractions. Twelve narrow molecular-weight-distribution polystyrene standards (obtained from Agilent Technologies, Inc.) within the range of 1.39-3039 kg/mol were used to generate a universal calibration curve. Mark-Houwink parameters were obtained from Appendix I of Mori, S.; Barth, H. G. Size Exclusion Chromatography; Springer, 1999. For polystyrene K=1.38×10⁻⁴ dl/g and α=0.7; and for polyethylene K=5.05×10⁻⁴ dl/g and α=0.693 were used. For a polymer fraction, which eluted at a temperature step, that has a weight fraction (weight % recovery) of less than 0.5%, the MWD and the molecular-weight averages were not computed; additionally, such polymer fractions were not included in computing the MWD and the molecular-weight averages of aggregates of fractions.

A BOCD indicates that lower molecular weight polymer chains in the polymer have a high density (e.g., due to a lack of short chain branching (SCB)) while higher molecular weight segments have a low density (e.g. due to higher amounts of SCB). Conventional LDPE and LLDPE polymers have longer polymer chains that have a higher density than shorter polymer chains, which is a mirror image of the BOCD region. Some LLDPE polymers fall between BOCD and conventional LLDPE and have a uniform, but not necessarily narrow MWD (e.g., Mw1 and Mw2 for the two halves are similar to each other but the MWDs within each half could be narrow or broad).

The polyethylene copolymer may be the polymerization product of an ethylene monomer and one or more olefin comonomers, such as alpha-olefin comonomers. Alpha-olefin comonomers can have 3 to 12 carbon atoms, or from 4 to 10 carbon atoms, or from 4 to 8 carbon atoms. Olefin comonomers can be selected from the group consisting of propylene, 1-butene, 1-pentene, 1-hexene, 1-heptene, 1-octene, 4-methylpent-1-ene, 1-nonene, 1-decene, 1-undecene, 1-dodecene, 1-hexadecene, and the like, and any combination thereof, such as 1-butene, 1-hexene, and/or 1-octene. In some embodiments, a polyene is used as a comonomer. In some embodiments, the polyene is selected from the group consisting of 1,3-hexadiene, 1,4-hexadiene, cyclopentadiene, dicyclopentadiene, 4-vinylcyclohex-1-ene, methyloctadiene, 1-methyl-1,6-octadiene, 7-methyl-1,6-octadiene, 1,5-cyclooctadiene, norbornadiene, ethylidene norbornene, 5-vinylidene-2-norbornene, 5-vinyl-2-norbornene, and olefins formed in situ in the polymerization medium. In some embodiments, comonomers are selected from the group consisting of isoprene, styrene, butadiene, isobutylene, chloroprene, acrylonitrile, and cyclic olefins. In some embodiments, combinations of the olefin comonomers are utilized. In some embodiments, the olefin comonomer is selected from the group consisting of 1-butene and 1-hexene. The olefin comonomer content of the polyethylene copolymer can range from a low of about 0.1 wt %, 5 wt %, 5.5 wt %, 6 wt %, 6.5 wt %, 7 wt %, 7.5 wt %, 8 wt %, 8.5 wt %, 9 wt %, or 10 wt % to a high of about 15 wt %, 13 wt %, 12.5 wt %, 12 wt %, 11.5 wt %, 11 wt %, 10.5 wt %, 10 wt %, 9.5 wt %, or 9 wt %, on the basis of total weight of monomers in the polyethylene copolymer. The balance of the polyethylene comonomer is made up of units derived from ethylene (e.g., from a low of 85 wt %, 88 wt %, 90 wt %, 91 wt %, 92 wt %, 92.5 wt %, 93 wt %, 93.5 wt %, or 94 wt % to a high of 90 wt %, 91 wt %, 92 wt %, 92.5 wt %, 93 wt %, 93.5 wt %, 94 wt %, 94.5 wt %, 95 wt %, 95.5 wt %, 96 wt %, 97 wt %, 99 wt %, or 99.9 wt %). Ranges from any foregoing low end to any foregoing high end are contemplated herein (e.g., 88 wt % to 93 wt %, such as 85 wt % to 90 wt % ethylene-derived units and the balance olefin comonomer-derived content).

The polyethylene copolymers can also have a high load melt index (HLMI) (also referred to as I21 or I21.6 in recognition of the 21.6 kg loading used in the test) within the range from a low of 5 g/10 min, 10 g/10 min, 15 g/10 min, 20 g/10 min, 25 g/10 min, or 30 g/10 min to a high of 35 g/10 min, 40 g/10 min, 45 g/10 min, or 50 g/10 min; with ranges from any of the foregoing lows to any of the foregoing highs contemplated herein (e.g., 5 g/10 min to 50 g/10 min, such as 15 g/10 min to 50 g/10 min, alternatively 20 g/10 min to 40 g/10 min). The term “high load melt index” (“HLMI”), is the number of grams extruded in 10 minutes under the action of a standard load (21.6 kg) and is an inverse measure of viscosity. As provided herein, HLMI (121) is determined according to ASTM D1238-20 (190° C./21.6 kg) and is also sometimes referred to as I21 or I21.6.

The polyethylene copolymers can also have a molecular weight distribution (MWD) of about 3.7 to about 4.3. The MWD can also range from a low of about 3.7, 3.8, or 3.9 to a high of about 3.9, 4.0, 4.1, 4.2, or 4.3, with ranges from any foregoing low to any foregoing high contemplated, provided the high end of the range is greater than the low end. MWD is defined as the weight average molecular weight (Mw) divided by number-average molecular weight (Mn).

Weight-average molecular weight (Mw) of polyethylene copolymers of various embodiments may be within the range from 100,000 g/mol to 150,000 g/mol, such as 100,000 g/mol to 125,000 g/mol, such as 110,000 g/mol to 140,000 g/mol, alternatively 125,000 g/mol to 150,000 g/mol, with ranges from any foregoing low end to any foregoing high end contemplated.

Number-average molecular weight (Mn) of polyethylene copolymers of various embodiments may be within the range from 24,000 to 38,000 g/mol, such as 24,000 to 30,000 g/mol, such as 26,000 to 35,000 g/mol, such as 30,000 to 38,000 g/mol, with ranges from any foregoing low end to any foregoing high end contemplated.

Z-average molecular weight (Mz) of polyethylene copolymers of various embodiments may be within the range from 230,000 to 380,000 g/mol, such as 230,000 to 320,000 g/mol, or 250,000 to 350,000 g/mol, such as 290,000 to 380,000 g/mol, with ranges from any foregoing low end to any foregoing high end contemplated (e.g., 230,000 to 350,000 g/mol or 25,000 to 380,000 g/mol).

A short chain branching of polyethylene copolymers of various embodiments may be within the range from 20 branch/1000C to 25 branch/1000 C.

The distributions and the moments of molecular weight (Mw, Mn, Mw/Mn, etc.), the branching index (g′vis), and the short chain branching are determined by using a high temperature Gel Permeation Chromatography (Polymer Char GPC-IR) equipped with a multiple-channel band-filter based Infrared detector IR5, an 18-angle Wyatt Dawn Heleos light scattering detector and a 4-capillary viscometer with Wheatstone bridge configuration. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 ml/min and the nominal injection volume is 200 μL. The whole system including transfer lines, columns, and viscometer detector are contained in ovens maintained at 145° C. The polymer sample is weighed and sealed in a standard vial with 80-μL flow marker (Heptane) added to it. After loading the vial in the autosampler, polymer is automatically dissolved in the instrument with 8 ml added TCB solvent. The polymer is dissolved at 160° C. with continuous shaking for about 2 hours. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10 million g/mol. The MW at each elution volume is calculated with the following equation:

$$log M = \frac{log ( {K}_{PS} / K )}{a + 1} + \frac{{a}_{PS} + 1}{a + 1} log {M}_{PS}$$

where the variables with subscript “PS” stand for polystyrene while those without a subscript are the test samples. In this method, α_{PS}=0.67 and K_{PS}=0.000175 while a and K are for ethylene-hexene copolymers as calculated from empirical equations (Sun, T. et al. Macromolecules 2001, 34, 6812), in which a=0.695 and K=0.000579 (1-0.75Wt), where Wt is the weight fraction for hexane comonomer. It should be noted that the comonomer composition is determined by the ratio of the IR5 detector intensity corresponding to CH2 and CH3 channel calibrated with a series of PE and ethylene-hexene homo/copolymer standards whose nominal values are predetermined by NMR or FTIR. Here the concentrations are expressed in g/cm³, molecular weight is expressed in g/mol, and intrinsic viscosity (hence K in the Mark-Houwink equation) is expressed in dL/g.

The comonomer composition is determined by the ratio of the IR5 detector intensity corresponding to CH2 and CH3 channel calibrated with a series of PE and PP homo/copolymer standards whose nominal value are predetermined by NMR or FTIR. In particular, this provides the methyl number per 1000 total carbons (CH3/1000TC) (or branch/1000C) as a function of molecular weight. The short-chain branch (SCB) content per 1000TC (SCB/1000TC) is then computed as a function of molecular weight by applying a chain-end correction to the CH3/1000TC function, assuming each chain to be linear and terminated by a methyl group at each end.

The LS molecular weight (M) at each point in the chromatogram is determined by analyzing the LS output using the Zimm model for static light scattering

$$\frac{{K}_{o} c}{Δ R ( θ )} = \frac{1}{MP ( θ )} + 2 {A}_{2} c .$$

Here, ΔR(0) is the measured excess Rayleigh scattering intensity at scattering angle θ, c is the polymer concentration determined from the IR5 analysis, A₂ is the second virial coefficient, P(θ) is the form factor for a monodisperse random coil, and Ko is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145° C. and 2=665 nm. For purposes of the present disclosure and the claims thereto (dn/dc)=0.1048 for ethylene-hexene copolymers.

A high temperature Polymer Char viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the equation [η]=ηₛ/c, where c is concentration and is determined from the IR5 broadband channel output.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{a v g} = \frac{\sum {{c}_{i} [ η ]}_{i}}{\sum {c}_{i}}$$

where the summations are over the chromatographic slices, i, between the integration limits. The branching index g′ᵥᵢₛ is defined as

$${g}_{vis}^{′} = \frac{{[ η ]}_{avg}}{{KM}_{ν}^{α}} ,$$

where Mᵥ is the viscosity-average molecular weight based on molecular weights determined by LS analysis and the K and ox are for the reference linear polymer, which are, for purposes of the present disclosure, α and K are the same as described above for linear polyethylene polymers.

Furthermore, the polyethylene copolymers can have a complex shear viscosity (η*) @ 0.01 rad/sec and 190° C. in the range of 5,000 Pa·s to 19,000 Pa·s; or from a low of any one of 5,000 Pa·s; 6,000 Pa·s; 7,000 Pa·s; 8,000 Pa·s; 9,000 Pa·s; 10,000 Pa·s; or 11,000 Pa·s, to a high of any one of 12,000 Pa·s; 13,000 Pa·s; 14,000 Pa·s; 15,000 Pa·s; 16,000 Pa·s; 17,000 Pa·s; 18,000 Pa·s; or 19,000 Pa's, with ranges from any low end to any high end contemplated (e.g., 6,000 to 8,000 Pa·s).

Complex shear viscosity (η*) @ 100 rad/sec and 190° C. may be in the range from 1300 Pa·s to 2500 Pa·s; such as from a low end of any one of 1300 Pa·s; 1400 Pa·s; 1500 Pa·s; or 1600 Pa·s to a high end of any one of 2100 Pa·s; 2200 Pa·s; 2300 Pa·s; 2400 Pa·s; or 2500 Pa·s, with ranges from any foregoing low to any foregoing high also contemplated (e.g., 1500 to 2300 Pa·s).

In some embodiments, the polyethylene copolymers have a shear thinning ratio (η*@ 0.01/100) less than 10, or in the range of 3 to 10, or 4 to 9, or 4 to 8.

Rheological data such as “Complex shear viscosity (η*),” reported in Pascal seconds, can be measured at 0.01 rad/sec and 100 rad/sec. Complex shear viscosity and other rheological measurements can be obtained from small angle oscillatory shear (SAOS) experiments. For instance, complex shear viscosity can be measured with a rotational rheometer such as an Advanced Rheometrics Expansion System (ARES-G2 model) or Discovery Hybrid Rheometer (DHR-3 Model) using parallel plates (diameter-25 mm) in a dynamic mode under nitrogen atmosphere. The rheometer can be thermally stable at 190° C. for at least 20 minutes before inserting compression-molded specimen onto the parallel plates. To determine the specimen's viscoelastic behavior, a frequency sweep in the range from 0.01 to 628 rad/s can be carried out at a temperature of 190° C. under constant strain that does not affect the measured viscoelastic properties. The sweep frequencies are equally spaced on a logarithmic scale, so that 5 frequencies are probed per decade. Depending on the molecular weight and temperature, strains of 3% can be used and linearity of the response is verified. A nitrogen stream is circulated through the oven to minimize chain extension or cross-linking during the experiments. The specimens can be compression molded at 190° C., without stabilizers. A sinusoidal shear strain can be applied. The shear thinning slope (STS) can be measured using plots of the logarithm (base ten) of the dynamic viscosity versus logarithm (base ten) of the frequency. The slope is the difference in the log (dynamic viscosity) at a frequency of 100 s⁻¹ and the log (dynamic viscosity) at a frequency of 0.01 s⁻¹ divided by 4. The complex shear viscosity (η*) versus frequency (ω) curves can be fitted using the Carreau-Yasuda model: η*−η_{∞}=(η₀−η_{∞})*(1+(λω)^{a})^{(n-1)/a}.

The five parameters in this model are: no, the zero-shear viscosity; λ, the relaxation time; and n, the power-law index; η_{∞}, the infinite rate viscosity; and a, the transition index. The zero-shear viscosity is the value at a plateau in the Newtonian region of the flow curve at a low frequency, where the dynamic viscosity is independent of frequency. The relaxation time corresponds to the inverse of the frequency at which shear-thinning starts. The power-law exponent describes the extent of shear-thinning, in that the magnitude of the slope of the flow curve at high frequencies approaches n−1 on a log (η*)−log (ω) plot. For Newtonian fluids, n=1 and the dynamic complex viscosity is independent of frequency.

“Shear Thinning Ratio”, which is reported as a unitless number, is characterized by the decrease of the complex viscosity with increasing shear rate. Herein, shear thinning can be determined as a ratio of complex viscosity at a frequency of 0.01 rad/s to the complex viscosity at a frequency of 100 rad/s.

Solubility distribution breadth index (SDBI) is used as a measure of the breadth of the solubility distribution curve for a given polymer. The procedure used herein for calculating SDBI is as described in PCT Patent Application WO 93/03093, pp. 16-18, published Feb. 18, 1993.

A SDBI of polyethylene copolymers of various embodiments may be within the range from 21.0° C. to 25.0° C., or 21.0° C. to 24.5° C., or 22.0° C. to 24.5° C.

### Waste-Processed Olefins

The processing of waste, such as plastic waste, may result in the production or recovery of olefins, or the attribution of waste feedstock to olefins, including any of the alpha-olefins disclosed herein, used in making the polymer compositions (e.g., polyethylene copolymers) disclosed herein. The waste may include plastic waste obtained from any source including, but not limited to, municipal, industrial, commercial or consumer sources. The plastic waste further may be obtained from a common source or from mixed sources, including mixed plastic waste obtained from municipal or regional sources and/or from waste streams of PET, HDPE, LDPE, LLDPE, polypropylene, and/or polystyrene. Furthermore, the waste may include thermoplastic elastomers and thermoset rubbers, such as from tires and other articles made from natural rubber, polybutadiene, styrene-butadiene, butyl rubber and EPDM.

The waste that is processed may also include any of various used polymeric and non-polymeric articles without limitation. Some examples of the many types of polymeric articles may include: films (including cast, blown, and otherwise), sheets, fibers, woven and nonwoven fabrics, furniture (e.g., garden furniture), sporting equipment, bottles, food and/or liquid storage containers, transparent and semi-transparent articles, toys, tubing and pipes, sheets, packaging, bags, sacks, coatings, caps, closures, crates, pallets, cups, non-food containers, pails, insulation, and/or medical devices. Further examples include automotive, aviation, boat and/or watercraft components (e.g., bumpers, grills, trim parts, dashboards, instrument panels and the like), wire and cable jacketing, agricultural films, geomembranes, playground equipment, and other such articles, whether blow molded, roto-molded, injection-molded, or the like. Any of the foregoing may include mixtures of polymeric and non-polymeric items (e.g., packaging or other articles may include inks, paperboards, papers, metal deposition layers, and the like). The ordinarily skilled artisan will appreciate that such polymeric articles may be made from any of various polymer and/or non-polymer materials, and that the polymer materials may vary widely (e.g., ethylene-based, propylene-based, butyl-based polymers, and/or polymers based on any C₂ to C₄₀ or even higher olefins, and further including polymers based on any one or more types of monomers, e.g., C₂ to C₄₀ α-olefin, di-olefin, cyclic olefin, etc. monomers). Common examples include ethylene, propylene, butylene, pentene, hexene, heptene, and octene; as well as multi-olefinic (including cyclic olefin) monomers such as ethylidene norbornene (ENB) and vinylidene norbornene (VNB) (including, e.g., when such cyclic olefins are used as comonomers, e.g., with ethylene monomers).

Processing of waste, such as through the pyrolysis of plastic waste, may directly produce or recover olefins used to make such polymer compositions or via the attribution of the use of the waste as a feed to a system, such as determined by crediting, allocating, and/or offsetting or substituting for other hydrocarbons in a mass or energy balance for a system, such as in accordance with a third party certification relating to circularity. Polymers that are certified for their circularity by third party certification may be referred to as certified circular. One example of such a certification is the mass balance chain of custody method set forth by the International Sustainability and Carbon Certification.

Various processes may be employed to produce, recover, or attribute to olefins used for the polymers disclosed herein. For example, olefins may be obtained from or in connection with the co-processing of waste, such as plastic waste, with other hydrocarbon feeds in a cracking, coking, hydroprocessing, and/or pyrolysis processes. For example, the olefins may be obtained directly or indirectly from fluid catalytic cracking units, delayed coking units, fluidized coking units (including FLEXICOKING™ units), hydroprocessing units (including hydrocracking and hydrotreating units), and/or steam cracking units (including gas or liquid steam cracking units) receiving such waste as a feed or co-feed. Alternatively, such units may receive a pyrolysis product of the processing of such waste (such as a separated or combined recycle pyrolysis gas and/or recycle pyrolysis oil) as a feed or cofeed. The olefins may be directly produced by such process or may be obtained by further processing, such as separation, treating, and/or cracking of an effluent of such processes. As an example, the olefins may be obtained by the processing of recycle pyrolysis oil and/or recycle pyrolysis gas produced from the pyrolysis of plastic waste. As used herein “recycle pyrolysis oil” refers to compositions of matter that are liquid when measured at 25° C. and 1 atm, and at least a portion of which are obtained from the pyrolysis of recycled waste (e.g., recycled plastic waste). As used herein “recycle pyrolysis gas” refers to compositions of matter that are a gas at 25° C. and 1 atm, and at least a portion of which are obtained from the pyrolysis of recycled waste. In addition, co-processing of waste, such as plastic waste, as a feed or co-feed into fluid catalytic cracking units, delayed coking units, fluidized coking units (including FLEXICOKING™ units), hydroprocessing units (including hydrocracking and hydrotreating units), and/or steam cracking units (including gas or liquid steam cracking units) may result in the attribution of the waste to olefins, polymers, or polymer compositions described herein, such as determined by crediting, allocating, and/or offsetting or substituting for other hydrocarbons in a mass or energy balance for a system, such as in accordance with a third party certification relating to circularity.

Accordingly, processes per various embodiments herein may further include obtaining olefins that have been produced or recovered from the processing of plastic waste or olefins to which the processing of plastic waste has been attributed, e.g., for employment in polymerization processes as elsewhere described herein; and polymer compositions (e.g., polyethylene copolymer) of various embodiments described herein may comprise olefins that have been produced or recovered from the processing of plastic waste or olefins to which the processing of plastic waste has been attributed. As an example, at least a portion of the olefin content (e.g., employed in processes and/or included in compositions as described herein) may be from olefins that are produced or recovered directly from the processing of plastic waste. Similarly, the processing of plastic waste may be attributed to at least a portion the olefins (e.g., employed in processes and/or included in compositions as described herein).

### Blends and Additives

In some embodiments, the polyethylene copolymers can be formulated (e.g., blended) with one or more other polymer components. In some embodiments, those other polymer components are alpha-olefin polymers such as polypropylene or polyethylene homopolymer and copolymer compositions. In some embodiments, those other polyethylene polymers are selected from the group consisting of linear low density polyethylene, high density polyethylene, medium density polyethylene, low density polyethylene, and other differentiated polyethylenes.

In some embodiments, the formulated blends can contain additives, which are determined based upon the end use of the formulated blend. In some embodiments, the additives are selected from the group consisting of fillers, antioxidants, phosphites, anti-cling additives, tackifiers, ultraviolet stabilizers, heat stabilizers, antiblocking agents, release agents, antistatic agents, pigments, colorants, dyes, waxes, silica, processing aids, neutralizers, lubricants, surfactants, and nucleating agents. In some embodiments, additives are present in an amount from 0.1 ppm to 5.0 wt %.

Polyethylene copolymers of the present disclosure can be optionally blended with one or more processing aids to form a polyethylene blend. Because of the improved properties of polyethylene copolymers of the present disclosure, advantageously, such processing aids can be omitted even in blown films (e.g., films, and particularly blown films, of some embodiments may be free of or substantially free of polymer processing aids, and especially polymer processing aids comprising fluorine; where “substantially free” means free of any intentionally added components, but allowing for up to 100 ppm of such component(s) as impurities).

### Polymerization Processes

The polymerization process preferably includes a gas phase polymerization reaction, and in particular a fluidized bed gas phase polymerization reaction. The gas-phase polymerization may be carried out in any suitable reactor system, e.g., a stirred- or paddle-type reactor system. See U.S. Pat. Nos. 7,915,357; 8,129,484; 7,202,313; 6,833,417; 6,841,630; 6,989,344; 7,504,463; 7,563,851; and 8,101,691 for discussion of suitable gas phase fluidized bed polymerization systems, which are well known in the art.

In such polymerization processes, a gas-phase, fluidized-bed process is conducted by passing a stream containing ethylene and an olefin comonomer continuously through a fluidized-bed reactor under reaction conditions and in the presence of a catalyst composition at a velocity sufficient to maintain a bed of solid particles in a suspended state. A stream (which may be called a “cycle gas” stream) containing unreacted ethylene and olefin comonomer is continuously withdrawn from the reactor, compressed, cooled, optionally partially or fully condensed, and recycled back to the reactor. Prepared polyethylene copolymer is withdrawn from the reactor and replacement ethylene and olefin comonomer are added to the recycle stream. In some embodiments, gas inert to the catalyst composition and reactants is present in the gas stream.

The cycle gas can include induced condensing agents (ICA). An ICA is one or more non-reactive alkanes that are condensable in the polymerization process for removing the heat of reaction. In some embodiments, the non-reactive alkanes are selected from C₁-C₅ alkanes, e.g., one or more of propane, butane, isobutane, pentane, isopentane, hexane, as well as isomers thereof and derivatives thereof. In some instances, mixtures of two or more such ICAs may be particularly desirable (e.g., propane and pentane, propane and butane, butane and pentane, etc.). Operation of gas phase fluidized bed reactors employing ICA can take place in “dry mode” (typically less than 5 mol % total ICA concentration with respect to total cycle gas), or in “condensing” or “condensed” mode, with higher ICA concentrations.

The polymerization process can be conducted substantially in the absence of catalyst poisons such as moisture, oxygen, carbon monoxide and acetylene. However, it is noted that oxygen may be added back to the reactor to alter the polymer structure and the polymer's performance characteristics.

Further, organometallic compounds can be employed as scavenging agents to remove catalyst poisons, thereby increasing the catalyst activity, or for other purposes. Adjuvants may also or instead be used in the process. Similarly, hydrogen gas may be added, thereby affecting the polymer molecular weight and distribution.

Often, a continuous cycle is employed wherein a first part of the cycle of a reactor, a cycling gas stream, otherwise known as a recycle stream or fluidizing medium, is heated in the reactor by the heat of polymerization. This heat is removed in a second part of the cycle by a cooling system external to the reactor.

The reactor pressure may vary from 100 psig (680 kPag)-500 psig (3448 kPag), or in the range of from 200 psig (1379 kPag)-400 psig (2759 kPag), or in the range of from 250 psig (1724 kPag)-350 psig (2414 kPag). In some embodiments, the reactor is operated at a temperature in the range of 60° C. to 120° C., 60° C. to 115° C., 70° C. to 110° C., 70° C. to 95° C., or 85° C. to 95° C.

The mole percent of ethylene may be from 25.0-90.0 mole percent, or 50.0-90.0 mole percent, or 70.0-85.0 mole percent, and the ethylene partial pressure is in the range of from 75 psia (517 kPa)-300 psia (2069 kPa), or 100-275 psia (689-1894 kPa), or 150-265 psia (1034-1826 kPa), or 200-250 psia (1378-1722 kPa). Ethylene concentration in the reactor can also range from 35-95 mol %, such as within the range from a low of 35, 40, 45, 50, or 55 mol % to a high of 70, 75, 80, 85, 90, or 95 mol % and further where ethylene mol % is measured on the basis of total moles of gas in the reactor (including, if present, ethylene and/or comonomer gases as well as inert gases such as one or more of nitrogen, isopentane or other ICA(s), etc.); as with vol-ppm hydrogen, this measurement may for convenience be taken in the cycle gas outlet rather than in the reactor itself. Comonomer concentration can range from 0.2-1.0 mol %, such as within the range from a low of 0.2, 0.3, 0.4 or 0.5 mol % to a high of 0.65, 0.70, 0.75, 0.80, 0.85, 0.90, 0.95, or 1.0 mol %.

### Catalysts

The catalysts employed in the polymerization can be metallocene catalysts. In particular, metallocene catalysts may be selected from the catalysts described in U.S. Pat. No. 6,956,088, incorporated herein by reference for all purposes.

### Articles of Manufacture

The polyethylene copolymers described herein can be blow molded into films, more specifically, extruded in a molten state through an annular die and then blown and cooled to form a tubular, blown film, which can then be axially slit and unfolded to form a flat film. More specifically, blown films can be prepared as follows. The polymer composition is introduced into the feed hopper of an extruder, such as a 50 mm extruder that is water-cooled, resistance heated, and has an L/D ratio of 30:1. The film can be produced using a 28 cm die with a 1.4 mm die gap, along with a dual air ring and internal bubble cooling. The film is extruded through the die into a film cooled by blowing air onto the surface of the film. The film is drawn from the die typically forming a cylindrical film that is cooled, collapsed and, optionally, subjected to a desired auxiliary process, such as slitting, treating, sealing, or printing. Typical melt temperatures are from about 180° C. to about 230° C. Blown film rates are generally from about 3 to about 25 kilograms per hour per inch (about 4.35 to about 26.11 kilograms per hour per centimeter) of die circumference. The finished film can be wound into rolls for later processing. An illustrative blown film process and apparatus suitable for forming films according to embodiments of the present invention is described in U.S. Pat. No. 5,569,693.

The resultant films possess an excellent balance of mechanical properties, toughness, sealability and cling/adhesive properties. The films can also be used for shrink films and form fill and seal applications requiring abuse resistance. The films also possess good softness/feel and optical/clarity properties useful for food packaging at any temperature.

A seal initiation temperature for blown films comprising the polyethylene copolymers described may be 80° C. or less, or 75° C. or less, or within the range from 65° C. to 80° C., such as 65° C. to 75° C., or 70° C. to 80° C. The seal initiation temperature is determined using 1 inch film strip of 1 mil gauge, sealed at various temperatures under 73 psi (0.5 N/mm²) for 1 second. Following ASTM conditioning for 40 hours at 23°+2° C. and 50±10% relative humidity, the sealed specimen were tested in T-joint peel mode at 20 inch/min pulling speed. The seal initiation temperature is the first temperature at which a force of 4N or greater is required to pull apart the sample . . .

A hot tack initiation temperature for blown films comprising the polyethylene copolymers described may be 90° C. or less, or 70° C. to 90° C., or 70° C. to 87° C., or 75° C. to 87° C., or 75° C. to 85° C. Hot tack initiation temperature is determined using 1 inch film strip of 1 mil gauge, sealed at various temperatures (which unless otherwise specified are temperatures from 60° C. to 130° C. in 5° C. intervals) under 73 psi (0.5 N/mm²) for 0.5 second. After a 0.4 second delay, the sealed specimen were pulled at 200 mm/speed in T-joint peel mode. The hot tack initiation temperature is the first temperature at which a sample requires 5 N/25 mm or more of force to pull apart.

A max hot tack force for blown films comprising the polyethylene copolymers described may be 13 N/25 mm or greater, or within the range from 13 N/25 mm to 22 N/25 mm, such as 13 N/25 mm to 20 N/25 mm, or 17 N/25 mm to 22 N/25 mm. Max hot tack force is determined using 1 inch film strip of 1 mil gauge, sealed at various temperatures under 73 psi (0.5 N/mm²) for 0.5 second. After a 0.4 second delay, the sealed specimen were pulled at 200 mm/speed in T-joint peel mode. The max hot tack force is the maximum force in N/25 mm that a sample can withstand over the entire temperature range of testing, which unless otherwise specified is 60° C. to 130° C. in 5° C. intervals.

The 1% secant modulus (ASTM D882-18 using 1 inch by 7 inch strip) in the machine direction (MD) for blown films comprising the polyethylene copolymers described may be within the range from 17,000 psi to 25,000 psi, such as 17,000 psi to 21,000 psi, or 19,000 psi to 25,000 psi.

The 1% secant modulus (ASTM D882-18 using 1 inch by 7 inch strip) in the transverse direction (TD, 90° to the MD in the plane of the film) for blown films comprising the polyethylene copolymers described may be within the range from 18,000 psi to 35,000 psi, such as 18,000 psi to 25,000 psi, or 20,000 psi to 30,000 psi, or 25,000 psi to 35,000 psi.

The yield strength (ASTM D D882-18 using a 1 inch by 4 inch strip) in the MD for blown films comprising the polyethylene copolymers described may be within the range from 900 psi to 1300 psi, such as 900 psi to 1200 psi, or 1000 psi to 1300 psi.

The yield strength (ASTM D882-18 using a 1 inch by 4 inch strip) in the TD for blown films comprising the polyethylene copolymers described may be within the range from 900 psi to 1500 psi, such as 900 psi to 1300 psi, or 1100 psi to 1500 psi.

The tensile break strength (ASTM D882-18 using a 1 inch by 4 inch strip) in the MD for blown films comprising the polyethylene copolymers described may be within the range from 7000 psi to 10,000 psi, such as 7000 psi to 9000 psi, or 8000 psi to 10,000 psi.

The tensile break strength (ASTM D882-18 using a 1 inch by 4 inch strip) in the TD for blown films comprising the polyethylene copolymers described may be within the range from 7000 psi to 10,000 psi, such as 7000 psi to 9000 psi, or 8000 psi to 10,000 psi.

The elongation at break (ASTM D882-18 using a 1 inch by 4 inch strip) in the MD for blown films comprising the polyethylene copolymers described may be within the range from 250% to 600%, such as 250% to 400%, or 350% to 600%.

The elongation at break (ASTM D882-18 using a 1 inch by 4 inch strip) in the TD for blown films comprising the polyethylene copolymers described may be within the range from 250% to 600%, such as 250% to 400%, or 350% to 600%.

The elongation at yield (ASTM D882-18 using a 1 inch by 4 inch strip) in the MD for blown films comprising the polyethylene copolymers described may be within the range from 5.5% to 7.5%, such as 5.5% to 7.0%, or 6.0% to 7.5%.

The elongation at yield (ASTM D882-18 using a 1 inch by 4 inch strip) in the TD for blown films comprising the polyethylene copolymers described may be within the range from 5.5% to 7.5%, such as 5.5% to 7.0%, or 6.0% to 7.5%.

The Elmendorf tear (ASTM D1922-15 with conditioning for 40 hours at 23°±2° C. and 50±10% relative humidity) in the MD for blown films comprising the polyethylene copolymers described may be 200 g/mil or greater, or 250 g/mil or greater, or 300 g/mil or greater, or within the range from 200 g/mil to 400 g/mil, or 250 g/mil to 400 g/mil, or 300 g/mil to 400 g/mil. The units g/mil may be converted to kN/m where 1 g/mil-0.392 kN/m. The Elmendorf tear in the MD for blown films comprising the polyethylene copolymers described may be 75 kN/m or greater, or 100 kN/m or greater, or within the range from 75 kN/m to 175 kN/m, or 75 kN/m to 125 kN/m, or 100 kN/m to 175 kN/m.

The Elmendorf tear (ASTM D1922-15 with conditioning for 40 hours at 23°±2° C. and 50±10% relative humidity) in the TD for blown films comprising the polyethylene copolymers described may be 250 g/mil or greater, or 300 g/mil or greater, or within the range from 250 g/mil to 450 g/mil, or 300 g/mil to 450 g/mil, or 350 g/mil to 450 g/mil. The Elmendorf tear in the TD for blown films comprising the polyethylene copolymers described may be 110 kN/m or greater, or 120 kN/m or greater, or within the range from 110 kN/m to 170 kN/m, or 110 kN/m to 150 kN/m, or 140 kN/m to 170 kN/m.

The dart drop (ASTM D1709-16, Phenolic, Method A) for blown films comprising the polyethylene copolymers described may be within the range from 500 g/mil to 1200 g/mil, or 500 g/mil to 1000 g/mil, or 700 g/mil to 1200 g/mil. The dart drop (ASTM D-1709, Phenolic, Method A) for blown films comprising the polyethylene copolymers described may be within the range from 200 kN/m to 500 kN/m, or 200 kN/m to 400 kN/m, or 300 kN/m to 500 kN/m.

The puncture peak force (ASTM D5748-19 where a ¾ inch stainless steel uncoated probe was used with two 0.25 mil HDPE slip sheets, machine model United SFM-1, testing speed 10 in/min) may be within the range from 10.5 pounds force per mil (lbf/mil) to 14.0 lbf/mil, or 10.5 lbf/mil to 13.5 lbf/mil, or 11.0 lbf/mil to 14.0 lbf/mil.

The puncture break energy (ASTM D5748-19 where a ¾ inch stainless steel uncoated probe was used with two 0.25 mil HDPE slip sheets, machine model United SFM-1, testing speed 10 in/min) may be within the range from 35 in*lbs/mil to 47 in*lbs/mil, or 35 in*lbs/mil to 42 in*lbs/mil, or 37 in*lbs/mil to 47 in*lbs/mil.

The haze (ASTM D1003-13) for blown films comprising the polyethylene copolymers described may be within the range from 8.0% to 12.5%, or 8.0% to 10.5%, or 10.0% to 12.5%.

The polyethylene copolymers (or blends thereof) may be formed into monolayer or multilayer films. These films may be formed by any of the conventional techniques including extrusion, co-extrusion, extrusion coating, lamination, blowing and casting. The film may be obtained by the flat film or tubular process which may be followed by orientation in a uniaxial direction or in two mutually perpendicular directions in the plane of the film. One or more of the layers of the film may be oriented in the transverse and/or longitudinal directions to the same or different extents. This orientation may occur before or after the individual layers are brought together. For example a polyethylene copolymer (or blend thereof) layer can be extrusion coated or laminated onto an oriented polypropylene layer or the polyethylene copolymer (or blend thereof) and polypropylene can be coextruded together into a film then oriented. Likewise, oriented polypropylene could be laminated to oriented polyethylene copolymer (or blend thereof), or oriented polyethylene copolymer (or blend thereof) could be coated onto polypropylene then optionally the combination could be oriented even further.

Films include monolayer or multilayer films. Specific end use films include, for example, blown films, cast films, stretch films, stretch/cast films, stretch cling films, stretch handwrap films, machine stretch wrap, shrink films, shrink wrap films, greenhouse films, laminates, and laminate films. Exemplary films are prepared by any conventional technique known to those skilled in the art, such as for example, techniques utilized to prepare blown, extruded, and/or cast stretch and/or shrink films (including shrink-on-shrink applications).

In one embodiment, multilayer films (multiple-layer films) may be formed by any suitable method. The total thickness of multilayer films may vary based upon the application desired. A total film thickness of 5-100 μm, such as 10-50 μm, is suitable for most applications. Those skilled in the art will appreciate that the thickness of individual layers for multilayer films may be adjusted based on desired end-use performance, polymer(s) employed, equipment capability, and other factors. The materials forming each layer may be coextruded through a coextrusion feedblock and die assembly to yield a film with two or more layers adhered together but differing in composition. Coextrusion can be adapted for use in both cast film or blown film processes. Exemplary multilayer films have at least two, at least three, or at least four layers. In one embodiment the multilayer films are composed of five to ten layers.

Specific applications for films comprising the polyethylene copolymers described herein may include trash bags, adult care items, agricultural films, aluminum foil laminates, aluminum laminates, asphalt films, auto panel films, bacon packaging, bag-in-box liquid packaging applications, bakery goods, banana film, batch inclusion bags, bathroom tissue overwrap, biaxially oriented films, biaxially oriented polypropylene (BOPP) films, biscuits packages, boutique bags, bread bags, bubble wrap, building film, cake mix packaging, can liners, candy wrap, cardboard liquid packaging, carpet film, carry-out sacks, cement packaging, cereal liners, cheese packaging, chemical packaging, clarity films, coffee packaging, coin bags, collation shrink films, confectionary packaging, construction sheeting, construction film, consumer goods, consumer trash bags, continuous wrap, convenience packaging, cosmetics packaging, counter bags, cover film, cup/cutlery overwrap, deli and bakery wrap, detergent packaging, diaper backsheet, disposables (diapers, sanitary, etc), dry food packaging, dry grains, dunnage bags, fertilizer, fish & seafood packaging, food packaging, foundation film, freeze-dried products, freezer films, frozen food, fruit juice packaging, furniture bags, garden sacks, garment bags, geomembrane liners, gloves, gravel bags, green house films, grocery sacks, heavy duty-sacks, high clarity collation shrink film, high clarity films, high speed packaging applications, high stiffness overwrap film, horizontal form-fill-and-seal (HFFS) packaging, household wrap, hygiene overwrap films, ice bags, incision drape, industrial hardware packaging, industrial liner, industrial trash bags, industrial spare parts packaging, in store self-service bags, insulation bags, institutional liners, juice bags, kitchen rolls, landscaping bags, lamination films, light duty shrink film, lime bags, liners, liquid packaging, liquid and granular food packaging, low stiffness overwrap film, magazine overwrap, mailer bags, mailers envelopes/sacks, masking film, mayonnaise packaging, meat packaging, medical products, medical draping, medium duty bags, merchandise bags, metallized laminates, military hardware packaging, milk bags, milk powder packaging, modified atmosphere packaging, mulch film, multi-wall sack liner, newspaper bags, nose tissue overwrap, olive oil packaging, packaging of beans, packaging of cementations products such as grout, packaging of dry and sharp products, pallet shrink film, pancake batter bags, paper handkerchief overwrap, paper laminates, pasta overwrap, pelletized polymer, perfume packaging, personal care packaging, pesticides packaging, pharmaceuticals packaging, pigment packaging, pizza packaging, polyamide laminates, polyester laminates, potato product packaging, potting soil bags, pouches, poultry packaging, pre-formed pouches, produce bags, produce packaging, rack and counter film, ready-made food packaging, ready meal packaging, retortable product packaging, films for the rubber industry, sandwich bags, salt bags, sausage packaging, seafood packaging, shipping sacks, shrink bags, shrink bundling film, shrink film, shrink shrouds, shrink tray, shrink wrap, snack food packaging, soft drink packaging, soil bags, soup packaging, spice packaging, stand up pouches, storage bags, stretch films, stretch hooders, stretch wrap, supermarket bags, surgical garb, take out food bags, textile films, refuse bags, thermoformed containers, thin films, tissue overwrap, tobacco packaging, tomato packaging, ketchup packaging, trash bags, t-shirt bags, vacuum skin packaging, vegetable packaging, vertical form-fill-and-seal (FFS) packaging, horizontal FFS packaging, tubular FFS packaging, and water bottle packaging.

In addition to films, the resin blends described herein will find utility in other applications like, but not limited to: extrusion coating, injection molding, rotomolding, and blow molding applications.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

### Additional Embodiments

Embodiment 1. A polyethylene copolymer comprising: ethylene units; and 0.1 mol % to 15 wt % of C₃-C₁₈ alpha-olefin comonomer units, the polyethylene copolymer having: a density of 0.900 g/cm³ to 0.915 g/cm³, a melt index (MI, determined per ASTM D1238-20 at 190° C. and 2.16 kg loading) (12) of 0.5 g/10 min to 1.5 g/10 min, a melt index ratio of 15 to 40, a cross-fractional chromatography (CFC) central cross moment covariance of less than −500 K (kg/mol), a CFC correlation of −0.3 or less, a CFC equal halves Tw1-Tw2 of −30° C. or less and Mw1/Mw2 of 2 or greater, and a temperature rising elution fraction (TREF) T75-T25 30° C. to 36° C.

Embodiment 2. The polyethylene copolymer of Embodiment 1, wherein the polyethylene copolymer has the density of 0.900 g/cm³ to 0.914 g/cm³.

Embodiment 3. The polyethylene copolymer of Embodiment 1 or Embodiment 2, wherein the polyethylene copolymer has the density of 0.900 g/cm³ to 0.912 g/cm³.

Embodiment 4. The polyethylene copolymer of Embodiment 1 or any of Embodiments 2-3, wherein the polyethylene copolymer has a solubility distribution breadth index (SDBI) of 21.0° C. to 25.0° C.

Embodiment 5. The polyethylene copolymer of Embodiment 1 or any of Embodiments 2-4, wherein the polyethylene copolymer has a short chain branching of 20 branch/1000C to 25 branch/1000 C.

Embodiment 6. The polyethylene copolymer of Embodiment 1 or any of Embodiments 2-5, wherein the polyethylene copolymer comprises 10 mol % to 15 mol % of C₃-C₁₈ alpha-olefin comonomer units.

Embodiment 7. The polyethylene copolymer of Embodiment 1 or any of Embodiments 2-6, wherein the polyethylene copolymer has a Mw/Mn of 3.7 to 4.3.

Embodiment 8. A blown film comprising: a polyethylene copolymer comprising:

ethylene units; and 0.1 mol % to 15 wt % of C₃-C₁₈ alpha-olefin comonomer units, the polyethylene copolymer having: a density of 0.900 g/cm³ to 0.915 g/cm³, a melt index (MI, determined per ASTM D1238-20 at 190° C. and 2.16 kg loading) (12) of 0.5 g/10 min to 1.5 g/10 min, a melt index ratio of to 40, a cross-fractional chromatography (CFC) central cross moment covariance of less than −500 K (kg/mol), a CFC correlation of −0.3 or less, a CFC equal halves Tw1-Tw2 of 30° C. or less and Mw1/Mw2 of 2 or greater, and a temperature rising elution fraction (TREF) T75-T25 30° C. to 36° C.

Embodiment 9. The blown film of Embodiment 8, wherein the blown film has a seal initiation temperature of about 80° C. or less.

Embodiment 10. The blown film of Embodiment 8 or Embodiment 9, wherein the blown film has wherein the blown film has a seal initiation temperature of about 75° C. or less.

Embodiment 11. The blown film of Embodiment 8 or any of Embodiments 9-10, wherein the blown film has a max hot tack force of 13 N/25 mm or greater.

Embodiment 12. The blown film of Embodiment 8 or any of Embodiments 9-11, wherein the blown film has a max hot tack force of 17 N/25 mm to 22 N/25 mm.

Embodiment 13. The blown film of Embodiment 8 or any of Embodiments 9-12, wherein the blown film has an Elmendorf tear in a machine direction of 200 g/mil or greater.

Embodiment 14. The blown film of Embodiment 8 or any of Embodiments 9-13, wherein the blown film has an Elmendorf tear in a machine direction of 250 g/mil or greater.

Embodiment 15. The blown film of Embodiment 8 or any of Embodiments 9-14, wherein the blown film has an Elmendorf tear in a machine direction of 300 g/mil or greater.

Embodiment 16. The blown film of Embodiment 8 or any of Embodiments 9-15, wherein the blown film has a dart drop of 500 g/mil to 1200 g/mil.

Embodiment 17. The blown film of Embodiment 8 or any of Embodiments 9-16, wherein the blown film has a puncture peak force of 10.5 lbf/mil to 14.0 lbf/mil.

Embodiment 18. The blown film of Embodiment 8 or any of Embodiments 9-17, wherein the blown film has a puncture break energy of 35 in*lbs/mil to 47 in*lbs/mil.

To facilitate a better understanding of the embodiments of the present invention, the following examples of preferred or representative embodiments are given. In no way should the following examples be read to limit, or to define, the scope of the invention.

### Examples

Several mLLDPE samples (Inventive Samples 11-16) were synthesized using a Hf-metallocene catalyst according to Table 1. Comparative Samples C7-C17 are commercially available samples listed in Table 2. The properties of the Inventive Samples 11-16) and the Comparative Samples C7-C17 are provided in Tables 3A-3C. The FIG. 1s a plot of (Mw1/Mw2) (log scale) vs. (Tw1-Tw2) for the inventive and comparative samples.

TABLE 1

| Conditions | I1 | I2 | I3 | I4 | I5 | I6 |
|---|---|---|---|---|---|---|
| Reactor | 0.91 | 0.91 | 0.91 | 0.91 | 0.91 | 0.91 |
| Density | | | | | | |
| (g/cm³) | | | | | | |
| Bed | 168.08 | 169.78 | 170.06 | 171.20 | 171.50 | 171.50 |
| Temperature | | | | | | |
| (° F.) | | | | | | |
| Reactor | 290.10 | 290.10 | 289.80 | 290.20 | 290.20 | 290.00 |
| Pressure (psig) | | | | | | |
| Ethylene | 63.94 | 63.99 | 64.00 | 64.00 | 64.00 | 64.10 |
| Concentration | | | | | | |
| (mol %) | | | | | | |
| H₂ | 488.60 | 416.10 | 337.60 | 311.20 | 384.50 | 440.30 |
| Concentration | | | | | | |
| (ppm) | | | | | | |
| CX/C2 = Flow | 0.14 | 0.13 | 0.13 | 0.12 | 0.12 | 0.12 |
| Ratio (lb/lb) | | | | | | |
| iC5 | 3.60 | 3.70 | 3.50 | 3.73 | 3.83 | 3.84 |
| Composition | | | | | | |
| (mol %) | | | | | | |
| N₂ | 31.44 | 31.20 | 31.35 | 31.20 | 31.00 | 31.00 |
| Composition | | | | | | |
| (mol %) | | | | | | |
| Production | 146.5 | 148.2 | 159.7 | 154.2 | 161.5 | 154.7 |
| Rate | | | | | | |
| (lb/hr) | | | | | | |

TABLE 2

| Sample | Polyethylene Composition |
|---|---|
| C7 | EXCEED ® XP8784, available from ExxonMobil |
| C8 | EXACT ® ECD714 3236, available from ExxonMobil |
| C9 | EXCEED ® 1012, available from ExxonMobil |
| C10 | EXCEED ® 2012, available from ExxonMobil |
| C11 | EXCEED ® 1018, available from ExxonMobil |
| C12 | ELITE ® AT 6401N, available from Dow |
| C13 | ELITE ® 5400, available from Dow |
| C14 | AFFINITY ® PL1880G, available from Dow |
| C15 | EVOLUE ® SP0510, available from Mitsui |
| C16 | EVOLUE ® SP1510, available from Mitsui |
| C17 | EVOLUE ® SP1520, available from Mitsui |

TABLE 3A

| Property | I1 | I2 | I3 | I4 | I5 | I6 |
|---|---|---|---|---|---|---|
| Density (g/cm³) | 0.912 | 0.910 | 0.910 | 0.913 | 0.913 | 0.913 |
| I2 (g/10 min) | 1.36 | 0.83 | 0.51 | 0.52 | 0.86 | 1.26 |
| I21 (g/10 min) | 39.8 | 25.5 | 15.4 | 8.4 | 22.0 | 46.5 |
| MIR (I21/I2) | 29.28 | 30.66 | 30.16 | 16.15 | 25.57 | 36.94 |
| Mn (g/mol) | 26950 | 30013 | 35373 | 35498 | 30810 | 27908 |
| Mw (g/mol) | 106520 | 124055 | 141219 | 140827 | 118673 | 107569 |
| Mz (g/mol) | 257195 | 302737 | 342265 | 349307 | 290360 | 259445 |
| Mw/Mn | 3.95 | 4.13 | 3.99 | 3.97 | 3.85 | 3.85 |
| comonomer | hexene | hexene | hexene | hexene | hexene | hexene |
| % comonomer | 12.37 | 12.56 | 11.84 | 11.22 | 11.01 | 11.48 |
| (mol %) | | | | | | |
| CDBI (%) | 42.63 | 41.09 | 36.5 | 31.11 | 35.89 | 38.8 |
| SDBI (° C.) | 23.7 | 24 | 22.3 | 23 | 23.1 | 23.3 |
| T75-T25 (° C.) | 33.2 | 34.3 | 33.6 | 32.8 | 31 | 30.9 |
| Tw1 (° C.) | 51.1 | 49.6 | 52.5 | 55.9 | 55.2 | 54.5 |
| Tw2 (° C.) | 86.4 | 84.7 | 86.7 | 88.1 | 86.4 | 87.5 |
| Tw1 − Tw2 (° C.) | −35.3 | −35.1 | −34.2 | −32.1 | −31.1 | −33.0 |
| Mw1/Mw2 | 2.70 | 2.66 | 2.79 | 3.10 | 2.72 | 2.64 |
| Covariance | −1251.0 | −1388.0 | −1716.0 | −1891.0 | −1350.0 | −1137.0 |
| (K*(kg/mol)) | | | | | | |
| Correlation | −0.32 | −0.31 | −0.33 | −0.38 | −0.35 | −0.32 |
| SCB | 22.6 | 23.3 | 21.9 | 20.6 | 20.1 | 20.9 |
| (Branch/1000C) | | | | | | |
| η* @ 0.01 | 6334 | 10312 | 17981 | 17913 | 10055 | 6784 |
| rad/sec and | | | | | | |
| 190° C. (Pa*s) | | | | | | |
| η* @ 100 | 1503 | 1819 | 2304 | 2260 | 1827 | 1570 |
| rad/sec and | | | | | | |
| 190° C. (Pa*s) | | | | | | |
| η* @ 0.01 | 4 | 6 | 8 | 8 | 6 | 4 |
| divided by η* | | | | | | |
| @ 100 | | | | | | |

TABLE 3B

| Property | C7 | C8 | C9 | C10 | C11 |
|---|---|---|---|---|---|
| Density (g/cm³) | 0.914 | 0.909 | 0.912 | 0.912 | 0.919 |
| I2 (g/10 min) | 0.83 | 1.9 | 1.01 | 1.98 | 0.99 |
| I21 (g/10 min) | 24.5 | 30.9 | 16.5 | 32.6 | 15.24 |
| MIR (I21/I2) | 29.54 | 16.26 | 16.31 | 16.44 | 15.39 |
| Mn (g/mol) | 29655 | 35600 | 43229 | 36090 | 40273 |
| Mw (g/mol) | 120802 | 90707 | 108179 | 90936 | 108697 |
| Mz (g/mol) | 303057 | 161728 | 194122 | 162067 | 198185 |
| Mw/Mn | 4.07 | 2.55 | 2.5 | 2.52 | 2.7 |
| comonomer | hexene | hexene | hexene | hexene | hexene |
| % comonomer | 10.11 | 11.61 | 9.34 | 10.01 | 6.28 |
| (mol %) | | | | | |
| CDBI (%) | 42.76 | 77.41 | 74.43 | 74.71 | 59.73 |
| SDBI (° C.) | 20.2 | 19.6 | 20.4 | 20.7 | 22.5 |
| T75-T25 (° C.) | 27.6 | 15.9 | 13.5 | 14.1 | 11.6 |
| Tw1 (° C.) | 57.7 | 57.3 | 66.6 | 64.1 | 77.6 |
| Tw2 (° C.) | 87.0 | 77.6 | 83.8 | 82.4 | 88.8 |
| Tw1 − Tw2 (° C.) | −29.3 | −20.2 | −17.2 | −18.3 | −11.2 |
| Mw1/Mw2 | 2.72 | 1.00 | 1.02 | 0.98 | 1.13 |
| Covariance | −1139.0 | 46.0 | 45.0 | 86.0 | 18.0 |
| K*(kg/mol)) | | | | | |
| Correlation | −0.31 | 0.02 | 0.03 | 0.06 | 0.01 |
| SCB | 19.9 | 22.6 | 17.0 | 19.1 | 12.7 |
| (Branch/1000 C) | | | | | |
| η* @ 0.01 | 10611 | 3940 | 7133 | 3772 | 7472 |
| rad/sec and | | | | | |
| 190° C. (Pa*s) | | | | | |
| η* @ 100 | 1887 | 1797 | 2489 | 1799 | 2661 |
| rad/sec and | | | | | |
| 190° C. (Pa*s) | | | | | |
| η* @ 0.01 | 6 | 2 | 3 | 2 | 3 |
| divided by | | | | | |
| η* @ 100 | | | | | |

TABLE 3C

| Property | C12 | C13 | C14 | C15 | C16 | C17 |
|---|---|---|---|---|---|---|
| Density (g/cm³) | 0.912 | 0.916 | 0.903 | 0.906 | 0.913 | 0.913 |
| I2 (g/10 min) | 0.87 | 1.02 | 1.04 | 1.14 | 0.88 | 1.96 |
| I21 (g/10 min) | 18.29 | 30.45 | 30.73 | 21.24 | 15.6 | 30.67 |
| MIR (I21/I2) | 21.02 | 29.85 | 29.55 | 18.63 | 17.73 | 15.65 |
| Mn (g/mol) | 43697 | 28673 | 40535 | 35686 | 35245 | 35779 |
| Mw (g/mol) | 105085 | 103402 | 87306 | 105521 | 114826 | 89545 |
| Mz (g/mol) | 198405 | 259562 | 152493 | 210224 | 224219 | 160353 |
| Mw/Mn | 2.4 | 3.61 | 2.15 | 2.96 | 3.26 | 2.5 |
| comonomer | octene | octene | octene | hexene | hexene | hexene |
| % comonomer | 10.12 | 9.48 | 14.66 | 13.75 | 9.59 | 8.82 |
| (mol %) | | | | | | |
| CDBI (%) | 91.6 | 58.84 | 92.24 | 81.48 | 54.61 | −1 |
| SDBI (° C.) | 10.8 | 23.5 | 16.4 | 21.5 | 22.1 | 21.08 |
| T75-T25 (° C.) | 4.5 | 21.3 | 8.8 | 16.3 | 21.8 | 4.49 |
| Tw1 (° C.) | 72.6 | 63.4 | N/A | 51.7 | 62.7 | N/A |
| Tw2 (° C.) | 79.8 | 87.0 | N/A | 72.9 | 86.0 | N/A |
| Tw1 − Tw2 (° C.) | −7.2 | −23.6 | N/A | −21.1 | −23.3 | N/A |
| Mw1/Mw2 | 0.66 | 1.68 | N/A | 0.89 | 1.43 | N/A |
| Covariance | 265.0 | −84.0 | N/A | 201.0 | −275.0 | N/A |
| K*(kg/mol)) | | | | | | |
| Correlation | 0.23 | −0.03 | N/A | 0.09 | −0.1 | N/A |
| SCB | 15.3 | 14.6 | 21.6 | 26.3 | 19.0 | 17.4 |
| (Branch/1000C) | | | | | | |
| η* @ 0.01 | 10891 | 12746 | 12771 | 6497 | 8359 | 3669 |
| rad/sec and | | | | | | |
| 190° C. (Pa*s) | | | | | | |
| η* @ 100 | 2243 | 1533 | 1560 | 2042 | 2419 | 1755 |
| rad/sec and | | | | | | |
| 190° C. (Pa*s) | | | | | | |
| η* @ 0.01 | 5 | 8 | 8 | 3 | 3 | 2 |
| divided by η* | | | | | | |
| @ 100 | | | | | | |

N/A is not measured.

The samples were formed into films using a blown film line with a die diameter of 160 mm, a 2.5:1 blow-up ratio (BUR), and a die temperature of about 390° F. to about 410° F. Films were made with a die gap of 90 mil (E1-E6 and C7) or 60 mil (C8-C12 and C14-C15), a line speed of about 240 ft/min to about 250 ft/min (E1-E6, C7 C9, C11, C12) or about 220 ft/min (C8, C10, C14, C15), a die factor of about 15 lb/hr/(in die circumference) (E1-6 and C7, C9, C11, and C11-C12) or about 13 lb/hr/(in die circumference) (C8, C10, and C14-C15). The film properties are provide in Tables 4A-4C.

TABLE 4A

| Property | I1 | I2 | I3 | I4 | I5 | I6 |
|---|---|---|---|---|---|---|
| Gauge (mil) | 1 | 1 | 1 | 1 | 1 | 1 |
| 1% Secant MD | 18005 | 18860 | 19021 | 22414 | 20902 | 20834 |
| (psi) | | | | | | |
| 1% Secant TD | 19969 | 23805 | 28117 | 33669 | 27592 | 24826 |
| (psi) | | | | | | |
| Yield Strength | 1064 | 1074 | 1112 | 1200 | 1138 | 1124 |
| MD (psi) | | | | | | |
| Yield Strength | 1064 | 1127 | 1207 | 1360 | 1220 | 1215 |
| TD (psi) | | | | | | |
| Elongation at | 6.86 | 7.15 | 6.68 | 6.67 | 6.42 | 6.15 |
| Yield MD (%) | | | | | | |
| Elongation at | 6.86 | 6.20 | 6.00 | 5.68 | 6.54 | 6.84 |
| Yield TD (%) | | | | | | |
| Tensile Break | 7378 | 8023 | 9200 | 9431 | 8614 | 8491 |
| Strength MD | | | | | | |
| (psi) | | | | | | |
| Tensile Break | 7378 | 7760 | 9027 | 8443 | 7941 | 7712 |
| Strength TD | | | | | | |
| (psi) | | | | | | |
| Elongation at | 584 | 337 | 297 | 298 | 358 | 401 |
| Break MD (%) | | | | | | |
| Elongation at | 584 | 577 | 593 | 631 | 597 | 603 |
| Break TD (%) | | | | | | |
| Elmendorf Tear | 205 | 240 | 254 | 373 | 256 | 229 |
| MD (g/mil) | | | | | | |
| Elmendorf Tear | 340 | 320 | 309 | 411 | 372 | 373 |
| TD (g/mil) | | | | | | |
| Elmendorf Tear | 80.3 | 93.9 | 99.4 | 146.2 | 100.2 | 89.6 |
| MD (kN/m) | | | | | | |
| Elmendorf Tear | 133.3 | 125.5 | 121.0 | 161.2 | 145.8 | 146.2 |
| TD (kN/m) | | | | | | |
| Haze (%) | 11.8 | 9.0 | 8.7 | 10.2 | 8.9 | 11.9 |
| Gloss MD (GU) | 49 | 56 | 58 | 48 | 54 | 43 |
| Gloss TD (GU) | 50 | 58 | 56 | 44 | 50 | 44 |
| Dart Drip | 763 | 961 | 1081 | 1027 | 817 | 619 |
| Phenolic | | | | | | |
| Method A (g) | | | | | | |
| Dart Drip | 796 | 980 | 1094 | 1046 | 824 | 634 |
| Phenolic | | | | | | |
| Method A | | | | | | |
| (g/mil) | | | | | | |
| Dart Drip | 312 | 384 | 429 | 410 | 323 | 248 |
| Phenolic | | | | | | |
| Method A | | | | | | |
| (kN/m) | | | | | | |
| Puncture Peak | 10.70 | 11.06 | 13.29 | 12.02 | 11.38 | 10.41 |
| Force (lbf) | | | | | | |
| Puncture Peak | 11.17 | 11.28 | 13.45 | 12.23 | 11.47 | 10.65 |
| Force per mil | | | | | | |
| (lbf/mil) | | | | | | |
| Puncture Break | 40.08 | 38.43 | 44.65 | 36.90 | 38.21 | 36.26 |
| Energy (in*lbs) | | | | | | |
| Puncture Break | 41.84 | 39.18 | 45.20 | 37.57 | 38.52 | 37.12 |
| Energy per mil | | | | | | |
| (in*lbs/mil) | | | | | | |
| Max Hot Tack | 19.4 | 18.5 | 17.6 | 20.5 | 15.2 | 19.2 |
| Force (N/25 mm) | | | | | | |
| Seal Initiation | 70 | 70 | 70 | 80 | 80 | 75 |
| Temperature(° C.) | | | | | | |
| Hot Tack | 80 | 80 | 85 | 90 | 90 | 85 |
| Initiation | | | | | | |
| Temperature(° C.) | | | | | | |

TABLE 4B

| Property | C7 | C8 | C9 | C10 | C11 |
|---|---|---|---|---|---|
| Gauge (mil) | 1 | 1 | 1 | 1 | 1 |
| 1% Secant MD | 21776 | 11900 | 16068 | 14200 | 23,749 |
| (psi) | | | | | |
| 1% Secant TD | 26896 | 12200 | 17377 | 14700 | 25,996 |
| (psi) | | | | | |
| Yield Strength | 1174 | 820 | 975 | 920 | 1,313 |
| MD (psi) | | | | | |
| Yield Strength | 1229 | 780 | 914 | 910 | 1,398 |
| TD (psi) | | | | | |
| Elongation at | 6.47 | 8.2 | 7.4 | 7.6 | 7.4 |
| Yield MD (%) | | | | | |
| Elongation at | 6.00 | 7.9 | 6.5 | 9.3 | 8.5 |
| Yield TD (%) | | | | | |
| Tensile Break | 8847 | 10650 | 10622 | 10350 | 10034 |
| Strength MD | | | | | |
| (psi) | | | | | |
| Tensile Break | 8537 | 9780 | 9217 | 8460 | 9131 |
| Strength TD | | | | | |
| (psi) | | | | | |
| Elongation at | 337 | 507 | 454 | 531 | 492 |
| Break MD (%) | | | | | |
| Elongation at | 599 | 604 | 641 | 619 | 678 |
| Break TD (%) | | | | | |
| Elmendorf Tear | 231 | 222.6 | 209 | 249.3 | 273 |
| MD (g/mil) | | | | | |
| Elmendorf Tear | 372 | 283.4 | 329 | 315.9 | 410 |
| TD (g/mil) | | | | | |
| Elmendorf Tear | 90.7 | 87.3 | 81.9 | 97.7 | 107.0 |
| MD (kN/m) | | | | | |
| Elmendorf Tear | 145.6 | 111.1 | 129.0 | 123.8 | 160.7 |
| TD (kN/m) | | | | | |
| Haze (%) | 9.9 | 27.5 | 8.3 | >30 | 17.1 |
| Gloss MD (GU) | 48 | 21.2 | 61 | 19 | 37 |
| Gloss TD (GU) | 48 | 20.6 | 60 | 16.9 | 40 |
| Dart Drip | 889 | 693 | 1070 | 927 | 830 |
| Phenolic | | | | | |
| Method A (g) | | | | | |
| Dart Drip | 896 | N/A | 1103 | N/A | 865 |
| Phenolic | | | | | |
| Method A | | | | | |
| (g/mil) | | | | | |
| Dart Drip | 351 | N/A | 432 | N/A | 339 |
| Phenolic | | | | | |
| Method A | | | | | |
| (kN/m) | | | | | |
| Puncture Peak | 11.82 | 13.4 | 15.36 | 13 | 13.42 |
| Force (lbf) | | | | | |
| Puncture Peak | 11.92 | 13.8 | 15.83 | 13.6 | 13.98 |
| Force per mil | | | | | |
| (lbf/mil) | | | | | |
| Puncture Break | 38.96 | 46.1 | 51.38 | 46.9 | 44.49 |
| Energy (in*lbs) | | | | | |
| Puncture Break | 39.27 | 47.3 | 52.97 | 49.2 | 46.35 |
| Energy per mil | | | | | |
| (in*lbs/mil) | | | | | |
| Max Hot Tack | 14.1 | 8.4 | 15.6 | 10.8 | 14.7 |
| Force | | | | | |
| (N/25 mm) | | | | | |
| Seal Initiation | 85 | 75 | 85 | 85 | 100 |
| Temperature | | | | | |
| (° C.) | | | | | |
| Hot Tack | 95 | 80 | 100 | 95 | 105 |
| Initiation | | | | | |
| Temperature | | | | | |
| (° C.) | | | | | |

TABLE 4C

| Property | C12 | C13 | C14 | C15 | C16 | C17 |
|---|---|---|---|---|---|---|
| Gauge (mil) | 1 | 1 | 1 | 1 | 1 | 1 |
| 1% Secant MD | 16,177 | 24,452 | 9410 | 9310 | 16532 | 16626 |
| (psi) | | | | | | |
| 1% Secant TD | 17,718 | 27,740 | 10500 | 9670 | 19990 | 16452 |
| (psi) | | | | | | |
| Yield Strength | 1,031 | 1,244 | 750 | 730 | 988 | 953 |
| MD (psi) | | | | | | |
| Yield Strength | 994 | 1,295 | 675 | 640 | 945 | 918 |
| TD (psi) | | | | | | |
| Elongation at | 7.4 | 6 | 9.7 | 9.4 | 6.7 | 6.9 |
| Yield MD (%) | | | | | | |
| Elongation at | 6.3 | 6 | 9.2 | 7.8 | 5.3 | 6.4 |
| Yield TD (%) | | | | | | |
| Tensile Break | 8018 | 8371 | 9840 | 11100 | 7341 | 8827 |
| Strength MD | | | | | | |
| (psi) | | | | | | |
| Tensile Break | 7871 | 8150 | 9810 | 10900 | 7894 | 8674 |
| Strength TD | | | | | | |
| (psi) | | | | | | |
| Elongation at | 381 | 409 | 436 | 428 | 453 | 578 |
| Break MD (%) | | | | | | |
| Elongation at | 643 | 724 | 628 | 581 | 629 | 674 |
| Break TD (%) | | | | | | |
| Elmendorf Tear | 240 | 191 | 152 | 126.6 | 184.6 | 282.2 |
| MD (g/mil) | | | | | | |
| Elmendorf Tear | 524 | 647 | 370 | 248.6 | 321.4 | 359.5 |
| TD (g/mil) | | | | | | |
| Elmendorf Tear | 94.1 | 74.9 | 59.6 | 49.6 | 72.4 | 110.6 |
| MD (kN/m) | | | | | | |
| Elmendorf Tear | 205.4 | 253.6 | 145.0 | 97.5 | 126.0 | 140.9 |
| TD (kN/m) | | | | | | |
| Haze (%) | 2 | 11.4 | 2.4 | 14.5 | 1.09 | 0.67 |
| Gloss MD (GU) | 84 | 48 | 79.9 | 36.3 | 25.4 | 11.6 |
| Gloss TD (GU) | 84 | 47 | 80.8 | 35.2 | 31.1 | 11.5 |
| Dart Drip | 878 | 853 | 417 | 735 | ≥1358 | 1157 |
| Phenolic | | | | | | |
| Method A (g) | | | | | | |
| Dart Drip | 828 | 862 | N/A | N/A | ≥1358 | 1113 |
| Phenolic | | | | | | |
| Method A | | | | | | |
| (g/mil) | | | | | | |
| Dart Drip | 325 | 338 | N/A | N/A | ≥532 | 436 |
| Phenolic | | | | | | |
| Method A | | | | | | |
| (kN/m) | | | | | | |
| Puncture Peak | 15.12 | 10.2 | 15.1 | 15.2 | 11.51 | N/A |
| Force (lbf) | | | | | | |
| Puncture Peak | 14.26 | 10.3 | 15.5 | 16.1 | 11.51 | N/A |
| Force per mil | | | | | | |
| (lbf/mil) | | | | | | |
| Puncture Break | 55.78 | 29.9 | 50.2 | 46.5 | 40.15 | N/A |
| Energy (in*lbs) | | | | | | |
| Puncture Break | 52.62 | 30.2 | 51.8 | 49.5 | 40.14 | N/A |
| Energy per mil | | | | | | |
| (in*lbs/mil) | | | | | | |
| Max Hot Tack | 12.8 | 8.9 | 13.3 | 11.0 | 14.4 | 13.4 |
| Force | | | | | | |
| (N/25 mm) | | | | | | |
| Seal Initiation | 85 | 95 | 80 | 70 | 85 | 85 |
| Temperature | | | | | | |
| (° C.) | | | | | | |
| Hot Tack | 105 | 100 | 90 | 90 | 90 | 95 |
| Initiation | | | | | | |
| Temperature | | | | | | |
| (° C.) | | | | | | |

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A polyethylene copolymer comprising:
ethylene units; and
0.1 mol % to 15 wt % of C3-C18 alpha-olefin comonomer units, the polyethylene copolymer having:
a density of 0.900 g/cm³ to 0.915 g/cm³,
a melt index (MI, determined per ASTM D1238-20 at 190° C. and 2.16 kg loading) (12) of 0.5 g/10 min to 1.5 g/10 min,
a melt index ratio of 15 to 40,
a cross-fractional chromatography (CFC) central cross moment covariance of less than −500 K (kg/mol),
a CFC correlation of −0.3 or less,
a CFC equal halves Tw1-Tw2 of −30° C. or less and Mw1/Mw2 of 2 or greater, and
a temperature rising elution fraction (TREF) T75-T25 of 30° C. to 36° C.

2. The polyethylene copolymer of claim 1, wherein the polyethylene copolymer has density of 0.900 g/cm³ to 0.914 g/cm³.

3. The polyethylene copolymer of claim 1, wherein the polyethylene copolymer has density of 0.900 g/cm³ to 0.912 g/cm³.

4. The polyethylene copolymer of claim 1, wherein the polyethylene copolymer has a solubility distribution breadth index (SDBI) of 21.0° C. to 25.0° C.

5. The polyethylene copolymer of claim 1, wherein the polyethylene copolymer has a short chain branching of 20 branch/1000C to 25 branch/1000C.

6. The polyethylene copolymer of claim 1, wherein the polyethylene copolymer comprises mol % to 15 mol % of C3-C18 alpha-olefin comonomer units.

7. The polyethylene copolymer of claim 1, wherein the polyethylene copolymer has a Mw/Mn of 3.7 to 4.3.

8. A blown film comprising:
a polyethylene copolymer comprising:
ethylene units; and
0.1 mol % to 15 wt % of C3-C18 alpha-olefin comonomer units, the polyethylene copolymer having:
a density of 0.900 g/cm³ to 0.915 g/cm³,
a melt index (MI, determined per ASTM D1238-20 at 190° C. and 2.16 kg loading) (12) of 0.5 g/10 min to 1.5 g/10 min,
a melt index ratio of 15 to 40,
a cross-fractional chromatography (CFC) central cross moment covariance of less than −500 K (kg/mol),
a CFC correlation of −0.3 or less,
a CFC equal halves Tw1-Tw2 of 30° C. or less and Mw1/Mw2 of 2 or greater, and
a temperature rising elution fraction (TREF) T75-T25 30° C. to 36° C.

9. The blown film of claim 8, wherein the blown film has one or more of the following properties:
(a) a seal initiation temperature of about 80° C. or less;
(b) a max hot tack force of 13 N/25 mm or greater;
(c) an Elmendorf tear in a machine direction (MD Elmendorf tear) of 200 g/mil or greater;
(d) a dart drop of 500 g/mil to 1200 g/mil;
(e) a puncture peak force of 10.5 lbf/mil to 14.0 lbf/mil; and
(f) a puncture break energy of 35 in*lbs/mil to 47 in*lbs/mil.

10. The blown film of claim 9, having all of the properties (a)-(f).

11. The blown film of claim 9, wherein the seal initiation temperature of the blown film is 75° C. or less; and/or wherein the blown film has a max hot tack force of 17 N/25 mm to 22 N/25 mm.

12. The blown film of claim 9, wherein the MD Elmendorf tear of the blown film is 250 g/mil or greater.

13. The blown film of claim 12, wherein the MD Elmendorf tear of the blown film is 300 g/mil or greater.
